(19) United States
(12) Patent Application Publication
(10) Pub. No.: US 2012/0058410 A1
(43) Pub. Date: Mar. 8, 2012

(54) SOLID OXIDE FUEL CELL

(75) Inventors: Han Wool RYU, Seoul (KR); Eon Soo LEE, Gyeongsangbuk-do (KR); Jae Hyuk JANG, Seoul (KR); Hong Ryul LEE, Gyunggi-do (KR)

(73) Assignee: SAMSUNG ELECTRO-MECHANICS CO., LTD., Gyunggi-do (KR)

(21) Appl. No.: 13/165,138

(22) Filed: Jun. 21, 2011

(30) Foreign Application Priority Data
Sep. 3, 2010 (KR) 1020100086608

(51) Int. Cl. H01M 8/04; H01M 8/24

(52) U.S. Cl. 429/457

(57) ABSTRACT

Disclosed herein is a solid oxide fuel cell. The solid oxide fuel cell includes: a tubular first electrode support layer formed with a plurality of first passages; an inner electrolyte layer formed in the first electrode support layer; an inner second electrode layer formed on the inner surface of the first electrolyte layer and forming an inner second passage; an outer electrolyte layer formed on the outer surface of the first electrode support layer; and an outer second electrode layer formed on the outer surface of the second electrolyte layer and adjacent to the outer second passage.

### CROSS REFERENCE TO RELATED APPLICATION

This application claims the benefit of Korean Patent Application No. 10-2010-0086608, filed on Sep. 3, 2010, entitled “Solid Oxide Fuel Cell” which is hereby incorporated by reference in its entirety into this application.

### BACKGROUND OF THE INVENTION

1. Technical Field

The present invention relates to a solid oxide fuel cell.

2. Description of the Related Art

A solid oxide fuel cell (SOFC) is operated at the highest temperature (700 to 1000° C.) among fuel cells using solid oxide having oxygen or hydrogen ion conductivity as an electrolyte and all components of the solid oxide fuel cell are solid, such that the solid oxide fuel cell has a simpler structure, does not lead to problems, such as loss, supplement, corrosion of the electrolyte, does not require a noble metal catalyst, and facilitates the supply of fuel by the direct internal reforming, as compared to other fuel cells. Further, the solid oxide fuel cell discharges high-temperature gas, such that it can perform cogeneration using waste heat. Due to these advantages, research into the solid oxide fuel cell has been actively conducted in advanced countries such as USA, Japan, or the like, for the purpose of commercialization at the beginning of the 21st Century.

A general solid oxide fuel cell is configured to include a dense electrolyte layer having oxygen ion conductivity and porous cathode and anode layers positioned at both sides thereof.

Reviewing a basic operation principle of the solid oxide fuel cell (SOFC), the solid oxide fuel cell is an apparatus basically generating electricity by the oxidation reaction of hydrogen and carbon monoxide. In the anode layer and the cathode layer, the electrode reaction is performed on the basis of the following reaction formula 1.

Anode layer: H₂+O₂—→H₂O+2e-, CO+O₂—→CO₂+2e-

Cathode layer: O₂+4e-→2O₂—

Entire reaction: H₂+CO+O₂→H₂0+CO₂ (Reaction Formula 1)

That is, oxygen reaches the electrolyte through the porous cathode layer and the oxygen ion generated by the reduction reaction of oxygen moves to the anode layer through the dense electrolyte layer and again reacts with hydrogen supplied to the porous anode layer, thereby generating water. In this case, electrons are generated in the anode layer and are consumed in the cathode layer. As a result, when two electrodes are connected to each other, electricity flows.

Electricity is generated by the foregoing reaction. In this case, the efficiency of the solid oxide fuel cell is determined by a contact area between the anode layer or the cathode layer and the electrolyte layer.

When the existing fuel cell is formed in a cylindrical shape, it has a simple shape where the electrolyte layer and the cathode layer or the anode layer are formed on an anode layer or cathode layer support tube. Since the fuel cell uses only one surface of the electrode layer, there is a problem in that the efficiency of the fuel cell is limited.

### SUMMARY OF THE INVENTION

The present invention has been made in an effort to provide a high-efficient solid oxide fuel cell having a double structure by forming second electrode layers at an inner side and an outer side in respects to a tubular-shaped first electrode support layer in order to perform reaction at both sides of a single fuel cell.

According to a preferred embodiment of the present invention, there is provided a solid oxide fuel cell, including: a tubular anode support layer formed with a plurality of fuel passages into which fuel is introduced; an inner electrolyte layer formed on an inner surface of the tubular anode support layer; an inner cathode layer formed on the inner surface of the inner electrolyte layer and forming an inner air passage into which air is introduced; an outer electrolyte layer formed on the outer surface of the tubular anode support layer; and an outer cathode layer formed on the outer surface of the outer electrolyte layer and adjacent to the outer air passage into which air is introduced.

The plurality of fuel passages formed on the tubular anode support layer may have the same distance as the electrolyte layer.

The plurality of fuel passages formed on the tubular anode support layer are formed on the inner side of the tubular anode support layer to be spaced apart from each other at predetermined intervals.

The plurality of fuel passages formed on the tubular anode support layer may have the same cross sectional area.

The cross section of the solid oxide fuel cell may have any one of a circular shape, a polygonal shape, and a flat-tubular shape.

The flat-tubular solid oxide fuel cell may have one or more bridge formed on the inner cathode layer.

According to another preferred embodiment of the present invention, there is provided a solid oxide fuel cell, including: a tubular cathode support layer formed with a plurality of air passages into which air is introduced; an inner electrolyte layer formed on an inner surface of the tubular cathode support layer; an inner anode layer formed on the inner surface of the inner electrolyte layer and forming an inner fuel passage into which fuel is introduced; an outer electrolyte layer formed on the outer surface of the tubular cathode support layer; and an outer anode layer formed on the outer surface of the outer electrolyte layer and adjacent to the outer fuel passage into which fuel is introduced.

The plurality of air passages formed on the tubular cathode support layer may have the same distance as the electrolyte layer.

The plurality of air passage formed on the tubular cathode support layer may be formed on the inner side of the tubular cathode support layer but spaced apart from each other at predetermined intervals.

The plurality of air passages formed on the tubular cathode support layer may have the same cross sectional area.

The cross section of the solid oxide fuel cell may have any one of a circular shape, a polygonal shape, and a flat-tubular shape.

The flat-tubular solid oxide fuel cell may have one or more bridge formed on the inner anode layer.

### BRIEF DESCRIPTION OF THE DRAWINGS

FIG. 1 is a perspective view of a solid oxide fuel cell according to a first preferred embodiment of the present invention;

FIGS. 2 and 3 are front cross-sectional views and side cross-sectional views of the solid oxide fuel cell shown in FIG. 1;

FIGS. 4 and 5 are front cross-sectional views and side cross-sectional views showing a solid oxide fuel cell according to a second preferred embodiment of the present invention;

FIG. 6 is a front cross-sectional view showing a modified example of the solid oxide fuel cell shown in FIGS. 1 to 3; and

FIG. 7 is a front cross-sectional view showing a modified example of the solid oxide fuel cell shown in FIGS. 4 and 5.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

Hereinafter, preferred embodiments according to the present invention will be described in detail with reference to the accompanying drawings.

A support-type fuel cell according to the prior art generally has a structure where an electrolyte layer, a second electrode layer, and the like are sequentially formed on a first electrode support layer, which may be similarly applied to a tubular fuel cell. However, the present invention has a double structure where an electrolyte layer and a second electrode layer are each sequentially formed at an inner side and an outer side in respects to a first electrode support layer.

In the fuel cell according to the present invention, the first electrode support layer and the second electrode layer may each be formed as an anode supply layer and a cathode layer or may each be formed as a cathode support layer and an anode layer. Therefore, a material introduced into a first passage and a second passage is determined as air or fuel.

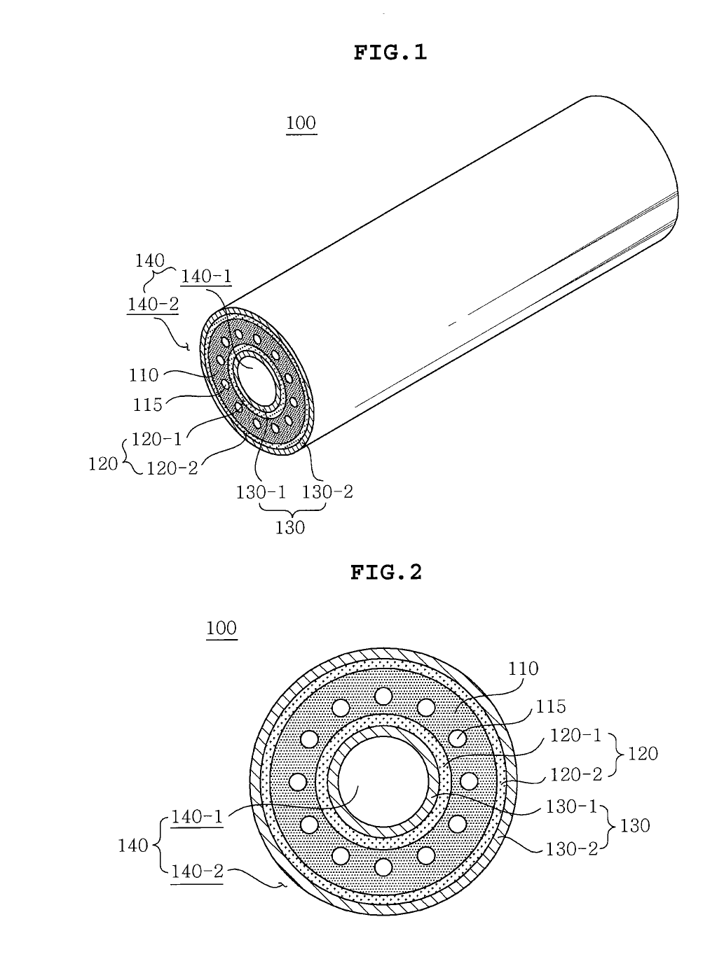

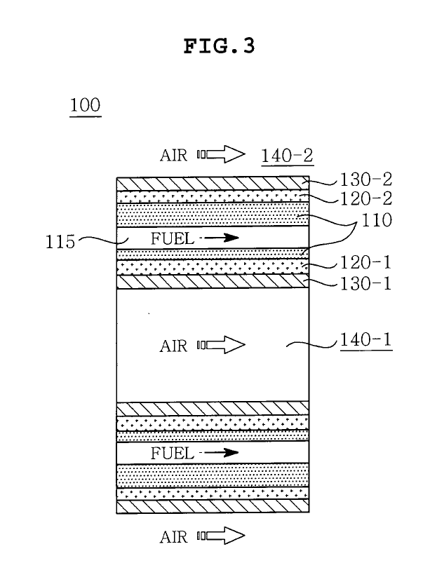

First, an anode support-type solid oxide fuel cell according to a first preferred embodiment of the present invention is shown in FIGS. 1 to 3. FIG. 1 is a perspective view of a solid oxide fuel cell according to a first preferred embodiment of the present invention and FIGS. 2 and 3 are front cross-sectional views and side cross-sectional views of the solid oxide fuel cell shown in FIG. 1.

Hereinafter, the anode support-type solid oxide fuel cell 100 (hereinafter, referred to as a fuel cell) according to the first preferred embodiment will be described with reference to FIGS. 1 to 3.

First, the anode support layer 110 in a tubular shape supports the entire fuel cell 100. Oxidation reaction of hydrogen and carbon monoxide introduced into the fuel cell 100 is performed.

The anode support layer 110 may use cermet consisting of metal nickel and oxide ion conductor. The metal nickel can greatly increase electrode catalyst activation due to the adsorption of hydrogen and hydrocarbon-based fuel, while having high electron conductivity. The metal nickel is used as a material for an electrode since it is very inexpensive as compared to platinum. In the case of the fuel cell operated at high temperature, a material (nickel/YSZ cermet) obtained by sintering a nickel oxide powder, including 40% to 60% of zirconia, may be used. However, the fuel cell is not limited thereto.

The anode support layer 110 is provided with a plurality of fuel passages 115 to which fuel is supplied. The anode support layer 110 keeps the support force of the fuel cell 100 while the flow of fuel is solved within the anode support layer 110 due to the formation of the plurality of fuel passages 115.

Since the anode support layer 110 has a tubular structure and oxygen ions are supplied from both sides of the anode support layer, the fuel passage 115 may have the same distance as the electrolyte layer 120 at the inner side or the outer side so that the oxygen ion introduced from both sides can react with fuel under the same conditions.

Further, in order to generate uniform reaction at the entire tubular-shaped anode support layer 110, the fuel passages 115 may be formed at the inner side of the anode support layer 110 to be spaced apart from each other at predetermined intervals. Therefore, the fuel passage 115 penetrates through the anode support layer 110 with a shape surrounded by the anode support.

For the foregoing reason, the plurality of fuel passages 115 may have the same cross-sectional area. The efficiency of the fuel cell is improved by preventing fuel from being concentrated at the specific fuel passage 115.

Meanwhile, although FIG. 2 shows the circular fuel passage 115, the shape of the fuel passage 115 is not limited thereto and therefore, may have a modified shape such as a long flat-tubular shape, a polygonal shape, etc.

The electrolyte layer 120 is formed to be adjacent to the inner side and the outer side of the anode support layer 110. An inner electrolyte layer 120-1 is formed by being coated on the inner surface of the anode support layer 110 and an outer electrolyte layer 120-2 is formed by being coated on the outer surface of the anode support layer 110.

The electrolyte layer 120 adopts a solid oxide electrolyte. The solid oxide electrolyte may be formed as thinly as possible because ion conductivity is lower than that of a liquid electrolyte such as an aqueous solution or a melting salt and has lower voltage drop due to ohmic polarization. However, since a micro gap, pores, or scratches are easily generated, the solid oxide electrolyte requires homogeneity, densification, heat resistance, mechanical strength, and stability, and the like, including ion conductivity. As the material of the solid oxide electrolyte, yttria stabilized zirconia (YSZ) obtained by melting about 3% to 10% of yttria (Y₂O₃) in zirconia (ZrO₂) may be used.

In addition, the cathode layer 130 is formed to be adjacent to the electrolyte layer 120. An inner cathode layer 130-1 is formed to be adjacent to the inner surface of the inner electrolyte layer 120-1. The inner cathode layer 130-1 has an inner air passage 140-1 formed at the center thereof. The inner cathode layer 130-1 coated on the tubular inner electrolyte layer 120-1 have the same shape as the inner electrolyte layer, such that the inner air channel 140-1 introduced with air is formed at the center of the fuel cell 100.

The outer cathode layer 130-2 is formed to be adjacent to the outer side of the outer electrolyte layer 120-2. The outer cathode layer 130-2 is formed by being coated on the outer surface of the outer electrolyte layer 120-2.

Although not shown in FIGS. 1 to 3, when a stack structure is formed by gathering unit cells of the fuel cell 100 or a plurality of unit cells are fixed, a metal connecting plate is used. In this case, the metal connecting plate forms the outer surface of the fuel cell and the passage supplying air. The passage forms the outer air passage 140-2 formed at the outside of the outer cathode layer 130-2.

The cathode layer 130 having the structure uses Perovskite type oxide. In particular, Lanthanum Strontium Manganite ((La_{0.84} Sr_{0.16}) MnO₃) having high catalytic performance and electron conductivity may be generally used. Oxygen is converted into oxygen ion by the catalyst action of LaMnO3. Since the Perovskite type oxide including a transition metal has electron conductivity together with ion conductivity, it is suitable as a material of the cathode layer 130. However, in addition to the above-mentioned material, other suitable materials may be used for the cathode layer.

The fuel cell 100 according to the present invention has the above-mentioned structure to perform the oxidation/reduction reaction at both sides based on the anode support layer, such that it increases the efficiency approximately twice as much as that of the fuel cell according to the prior art.

Referring to FIG. 3, the fuel flows in the fuel passage 115 formed on the anode support layer 110 and air flows in the air passage 140 formed at the inner side and the outer side of the anode support layer 110. The air introduced into the air passage 140 formed at the inner side and the outer side is ionized by passing through the porous cathode layer and reaches the anode support layer 110 passing through the solid oxide electrolyte layer 120. The air ion (oxygen ion) electrochemically reacts with fuel flowing in the fuel passage 115 formed on the porous anode support layer 110. The air ion approaches both sides of the anode support layer 110, thereby increasing the reaction efficiency.

Meanwhile, FIG. 1 shows the cylindrical fuel cell of which the cross section is a circle among the anode support-type fuel cells 100, but may be modified into any shape of a tubular shape, that is, a quadrangular pillar, a triangular pillar, a hexagonal pillar, a flat-tubular shape, or the like.

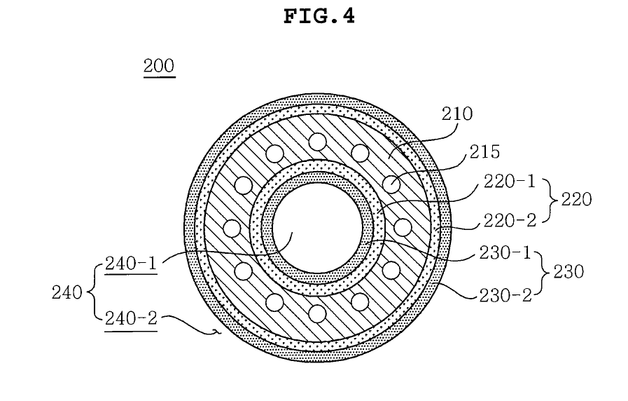

FIGS. 4 and 5 are front cross-sectional views and side cross-sectional views showing a fuel cell according to a second preferred embodiment of the present invention. Hereinafter, the fuel cell according to the second preferred embodiment will be described with reference to FIGS. 4 and 5. However, the detailed description of the same configuration as that described with reference to FIGS. 1 to 3 will be omitted.

A fuel cell 200 according to the second preferred embodiment configures a cathode support-type fuel cell 200. The tubular support layer formed with an air passage 215 becomes a cathode support layer 210 and the electrode layers formed at the inner side and the outer side of the cathode support layer 210 becomes an anode layer 230.

The electrolyte layer 220 is the same as the fuel cell shown in FIGS. 1 to 3, wherein air flows in the air passage 215 formed on the cathode support layer 210 and fuel flows in an inner fuel passage 240-1 formed at the center of the fuel cell and fuel flows in an outer fuel passage 240-2 formed at an outer side of an outer anode layer 230-2.

As shown in FIG. 5, air introduced through the air passage 215 formed on the cathode support layer 210 is ionized by passing through the cathode support layer and moves to the anode layer 230 formed at both sides of the cathode support layer 210 to electrochemically react in the inner anode layer 230-1 and the outer anode layer 230-2, respectively.

Therefore, the fuel cell according to the second preferred embodiment increases the efficiency approximately twice as much as that of the fuel cell according to the related art.

For the reason described with reference to FIGS. 1 to 3, the air passage 215 formed at the inner side of the cathode support layer 210 may be disposed to have the same distance as the electrolyte layer 220 formed at both sides of the cathode support layer 210 and the plurality of air passages 215 may be formed to be spaced apart from each other at predetermined intervals and the cross-sectional area thereof may be the same.

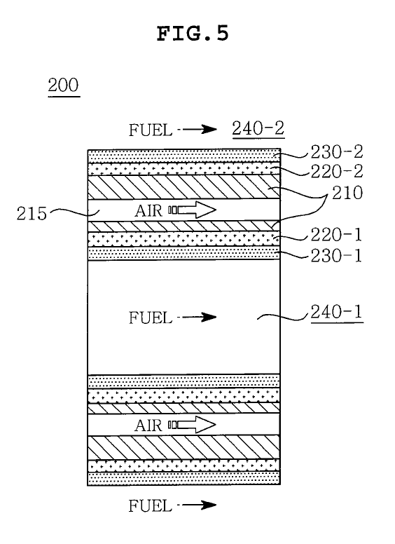

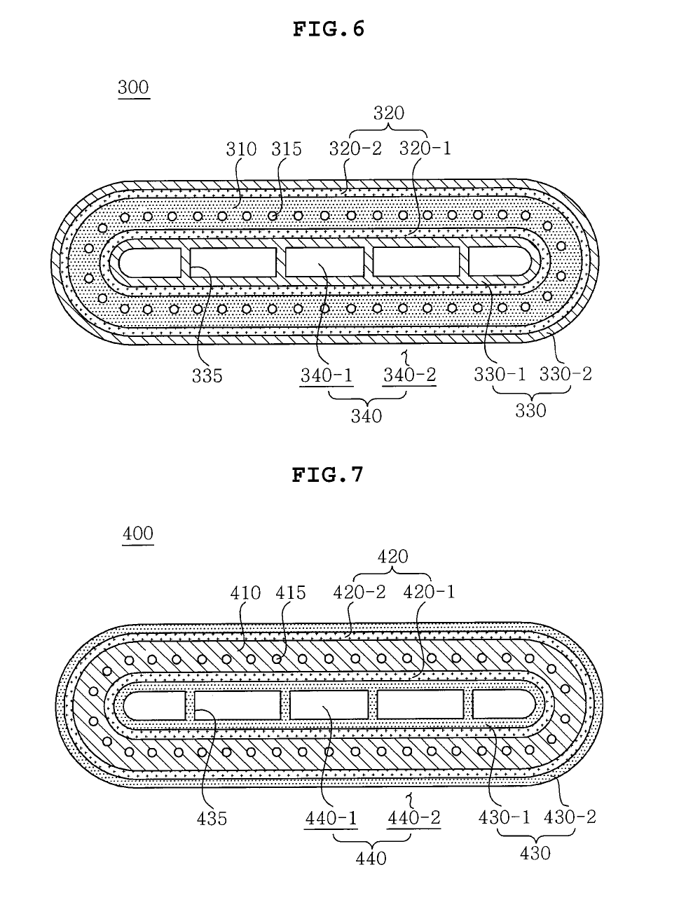

FIGS. 6 and 7 show front cross-sectional views of a flat-tubular fuel cell as another modified example of the present invention. A basic structure of a tubular fuel cell 300 shown in FIG. 6 is the same as the anode support type/cylindrical fuel cell with reference to FIGS. 1 to 3 and a basic structure of a tubular fuel cell 400 shown in FIG. 7 is the same as the cathode support type/cylindrical fuel cell described with reference to FIGS. 4 and 5.

In the anode support type/flat-tubular fuel cell 300, an inner electrolyte layer 320-1 is formed on an inner surface of an anode support layer 310 and an inner cathode layer 330-1 is formed on an inner surface of an inner electrolyte layer 320-1. In addition, an outer electrolyte layer 320-2 is formed on the outer surface of the anode support layer 310 and an outer cathode layer 330-2 is formed on an outer surface of an outer electrolyte layer 320-2.

The anode support layer 310 is porous and is provided with a plurality of fuel passages 315 in which fuel flows. In this case, the anode support layer 310 determining the shape of the fuel cell is formed in a flat-tubular shape, such that the shape of the fuel cell is determined as the flat-tubular shape.

In this case, in order to add the further support force to the flat-tubular fuel cell, the inner cathode layer 330-1 may be provided with one or more bridge 335 extending from one side to the other side. The bridge 335 divides an inner air passage 340-1. As shown in FIG. 6, when four bridges 335 are formed, the inner air passage 340-1 is divided into five passages.

Even though the bridge 335 is formed, the width is not wide, such that support force is added and the flow of air is not hindered.

FIG. 7 shows a cathode support type/flat-tubular fuel cell 400. The fuel cell 400 shown in shown in FIG. 7 may be formed by substituting the anode support layer with the anode in the fuel cell shown in FIG. 6 and therefore, the detailed description thereof will be omitted.

The solid oxide fuel cell according to the present invention forms the second electrode layers at the inner side and the outer side in respects to the tubular-shaped first electrode support layer of the single fuel cell, thereby making it possible to increase the reaction area approximately twice as much as that of the existing fuel cell.

Further, the present invention implements the fuel cell to have the integrated shape while increasing the reaction area approximately twice as much, thereby making it possible to increase the current collection efficiency in proportion to the increase in the reaction area.

The present invention forms the plurality of passages at the inner side of the first electrode support layer, thereby making it possible to easily introduce fuel or air and allows the first electrode support layer to support the fuel cell, thereby making it possible to implement the firm fuel cell even though the second electrode layer has the double structure.

Although the embodiments of the present invention regarding the touch panel have been disclosed for illustrative purposes, those skilled in the art will appreciate that a variety of different modifications, additions and substitutions are possible, without departing from the scope and spirit of the invention as disclosed in the accompanying claims. Accordingly, such modifications, additions and substitutions should also be understood as falling within the scope of the present invention.

What is claimed is:

1. A solid oxide fuel cell, comprising:
a tubular anode support layer formed with a plurality of fuel passages into which fuel is introduced;
an inner electrolyte layer formed on an inner surface of the tubular anode support layer;
an inner cathode layer formed on the inner surface of the inner electrolyte layer and forming an inner air passage into which air is introduced;
an outer electrolyte layer formed on the outer surface of the tubular anode support layer; and
an outer cathode layer formed on the outer surface of the outer electrolyte layer and adjacent to the outer air passage into which air is introduced.

2. The solid oxide fuel cell as set forth in claim 1, wherein the plurality of fuel passages formed on the tubular anode support layer have the same distance as the electrolyte layer.

3. The solid oxide fuel cell as set forth in claim 1, wherein the plurality of fuel passages formed on the tubular anode support layer are formed on the inner side of the tubular anode support layer to be spaced apart from each other at predetermined intervals.

4. The solid oxide fuel cell as set forth in claim 1, wherein the plurality of fuel passages formed on the tubular anode support layer have the same cross sectional area.

5. The solid oxide fuel cell as set forth in claim 1, wherein the cross section of the solid oxide fuel cell has any one of a circular shape, a polygonal shape, and a flat-tubular shape.

6. The solid oxide fuel cell as set forth in claim 5, wherein the flat-tubular solid oxide fuel cell has one or more bridge formed on the inner cathode layer.

7. A solid oxide fuel cell, comprising:
a tubular cathode support layer formed with a plurality of air passages into which air is introduced;
an inner electrolyte layer formed on an inner surface of the tubular cathode support layer;
an inner anode layer formed on the inner surface of the inner electrolyte layer and forming an inner fuel passage into which fuel is introduced;
an outer electrolyte layer formed on the outer surface of the tubular cathode support layer; and
an outer anode layer formed on the outer surface of the outer electrolyte layer and adjacent to the outer fuel passage into which fuel is introduced.

8. The solid oxide fuel cell as set forth in claim 1, wherein the plurality of air passages formed on the tubular cathode support layer have the same distance as the electrolyte layer.

9. The solid oxide fuel cell as set forth in claim 1, wherein the plurality of air passages formed on the tubular cathode support layer are formed on the inner side of the tubular cathode support layer to be spaced apart from each other at predetermined intervals.

10. The solid oxide fuel cell as set forth in claim 1, wherein the plurality of air passages formed on the tubular cathode support layer have the same cross sectional area.

11. The solid oxide fuel cell as set forth in claim 1, wherein the cross section of the solid oxide fuel cell has any one of a circular shape, a polygonal shape, and a flat-tubular shape.

12. The solid oxide fuel cell as set forth in claim 11, wherein the flat-tubular solid oxide fuel cell has one or more bridge formed on the inner anode layer.
